(19) United States
(12) Patent Application Publication
(10) Pub. No.: US 2006/0149914 A1
(43) Pub. Date: Jul. 6, 2006

(54) Systems and methods for allocating data structures to memories

(76) Inventor: Tom F. Doris, London (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,759

(22) Filed: Dec. 30, 2004

(51) Int. Cl. G06F 12/00

(52) U.S. Cl. 711/172

(57) ABSTRACT

Systems and methods allocate data structures to memories coupled to a processor. The allocation may be based on system aspects such as memory size constraints, bandwidth constraints, and memory latency. Further aspects that may be included in the allocation decision are minimization of wasted bandwidth and task priorities. A constraint satisfaction algorithm with an objective function may be used to determine a desirable allocation.

### FIELD

The embodiments of the invention relate generally to memory allocation and more particularly to allocating data structures to memories.

### BACKGROUND

Modern computer processors have several RAM variants available. For instance, many processors may access on-chip scratchpad memory, high speed SRAM off chip, and finally external DRAM. The hierarchy typically moves from very fast and small to slow and large. It is desirable for performance reasons to have the most frequently used data in the fastest possible memory store.

However, computer software operating systems and applications typically involve several tasks, with each task using many data structures of varying sizes. Currently programmers or architects typically manually decide to store each data structure in a particular storage area. This is acceptable for small projects and experienced architects, but does not scale up to large projects with many data structures and many possible allocations. For such projects, manual allocation results in sub-optimal latency of access and therefore sub-optimal performance.

Further, as the number of data structures grows, the number of possible assignments grows rapidly. Finding an optimal solution is increasingly difficult when there are many small data structures so that there are many possible allocations of different permutations of data structures to a given storage channel.

### BRIEF DESCRIPTION OF THE DRAWINGS

FIG. 1 is a block diagram showing hardware and software components of a system incorporating embodiments of the invention.

FIG. 2 is a flowchart illustrating a method for allocating data structures to various memories according to embodiments of the invention.

FIG. 3 is a flowchart illustrating a method for implementing a constraint satisfaction algorithm according to embodiments of the invention.

### DETAILED DESCRIPTION

In the following detailed description of exemplary embodiments of the invention, reference is made to the accompanying drawings that form a part hereof, and in which is shown by way of illustration specific exemplary embodiments in which the inventive subject matter may be practiced. These embodiments are described in sufficient detail to enable those skilled in the art to practice the various embodiments of the invention, and it is to be understood that other embodiments may be utilized and that logical, mechanical, electrical and other changes may be made without departing from the scope of the inventive subject matter. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description.

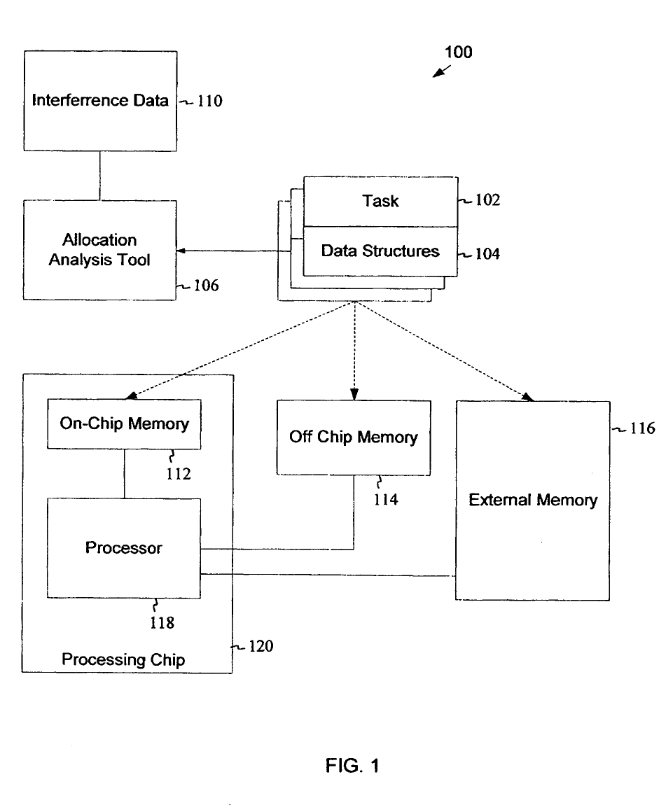

FIG. 1 is a block diagram of the major components of a hardware and software operating environment 100 incorporating various embodiments of the invention. Generally such hardware may include personal computers, server computers, mainframe computers, laptop computers, portable handheld computers, set-top boxes, network routers and switches, intelligent appliances, personal digital assistants (PDAs), cellular telephones and hybrids of the aforementioned devices. In some embodiments of the invention, operating environment 100 includes at least one processing chip 120 having at least one processor 118 and an on-chip memory 112 coupled by bus 122. In addition, processor 118 may be coupled to an off-chip memory 114 by bus 124. Further, processor 118 may be coupled to an external memory 116 by bus 126. The memories coupled to the system may be referred to as storage channels.

Processor 118 may be any type of computational circuit such as, but not limited to, a microprocessor, a complex instruction set computing (CISC) microprocessor, a reduced instruction set computing (RISC) microprocessor, a very long instruction word (VLIW) microprocessor, a graphics processor, a digital signal processor (DSP), or any other type of processor, processing circuit, execution unit, or computational machine. In some embodiments of the invention, processor 118 may be a processor in the Pentium®, Celeron® or Itanium® family of processors available from Intel Corporation, Santa Clara, Calif. However, the embodiments of the invention are not limiter to any particular type of processor. Although only one processor 118 is shown, multiple processors may be present in either system 100 or on processing chip 120.

On-chip memory 112, off-chip memory 114, and external memory 116 may be different types of memory and will typically have differing sizes, latencies, speeds, and other operating characteristics. For example, in some embodiments, on-chip memory 112 is a scratchpad memory, off-chip memory 114 is an SRAM (Static Random Access Memory) and external memory 116 is a DRAM (Dynamic Random Access Memory). However, the embodiments of the invention are not limited to a particular type of memory. For example, the memory may be SDRAM (Synchronous DRAM), DDR-SDRAM (Double Data Rate SDRAM) or any other type of memory. Typically, on-chip memory 112 is small and very fast, off-chip memory 114 is larger than and not as fast as memory 112, and external memory 116 is larger than, but slower than memories 112 and 114.

Further, the busses 122, 124 and 126 connecting memories 112, 114 and 116 respectively may also have varying bandwidths. Although one bus is shown for each memory coupling the processor, in some embodiments, memories may share a bus.

System 100 may include other hardware components not shown in FIG. 1 such as network interfaces (wired and wireless), storage interfaces (e.g. to hard drives, CD-ROM drives, DVD-ROM drives etc.) and video interfaces.

One or more tasks 102 may be assigned to run on processor 118. A task 102 may be a process, thread or other executable unit. Tasks also have one or more data structures 104. A typical system will have multiple tasks, potentially running on multiple processors, and each task will have multiple data structures. However, the embodiments of the invention are not limited to any particular number of processors, tasks, or data structures. During the operation of system 100, tasks perform read and write operations on their associated data structures. The frequency of such read and writes varies both within a task and from task to task.

Allocation analysis tool 106 analyzes tasks 102 to determine the frequency of reads and writes to data structures 104. In some embodiments, allocation analysis tool performs an up-front static analysis of the input and output references within the tasks to create read and write bandwidths. In alternative embodiments, allocation analysis tool 106 performs an empirical measurement of either a real execution of the code on hardware or a simulation thereof. In embodiments where tasks 102 perform networking related functions, the network traffic conditions under which the tasks execute may be a factor used in the analysis. The read and write bandwidths may be normalized across a short time period or in the case of a network processing task, across a packet arrival time.

In some embodiments, the read/write bandwidths may be maintained in an interference data structure 110. In some embodiments, the interference data structure may be an interference matrix, with rows representing tasks and columns representing data structures. In some embodiments, each entry in the interference matrix is a couplet. The first element of the couplet is the read bandwidth, the number of bytes read by the task from the data structure. The second element is the write bandwidth, the number of bytes written to the data structure. Table 1 below is an exemplary interference matrix having three tasks and four data structures. Those of skill in the art will appreciate that a system may have more or fewer tasks and data structures.

TABLE 1

| Task Data Structure | DS 0 | DS 1 | DS 2 | DS 3 | Total |
|---|---|---|---|---|---|
| Task A | (0, 1) | (0, 0) | (0, 0) | (0, 0) | (1, 1) |
| Task B | (0, 0) | (3, 3) | (2, 5) | (3, 3) | (8, 11) |
| Task C | (1, 1) | (3, 3) | (0, 0) | (2, 2) | (6, 6) |
| Total | (2, 2) | (6, 6) | (2, 5) | (5, 5) | (15, 18) |
| Total bw | 4 | 12 | 7 | 10 | 33 |

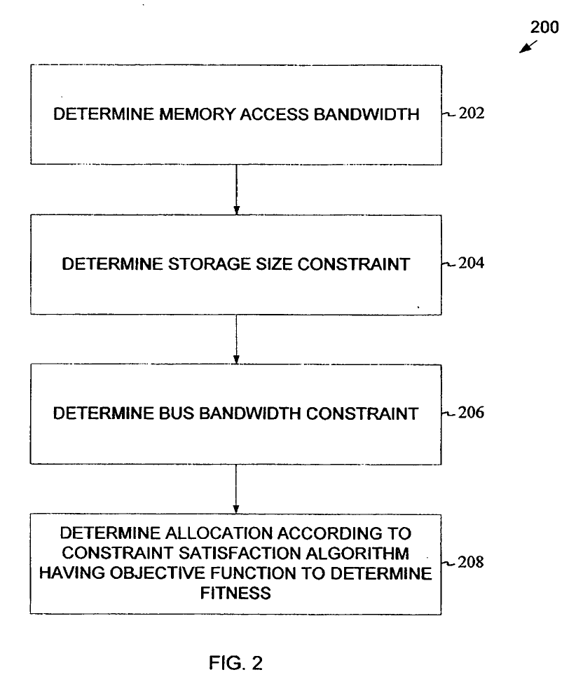

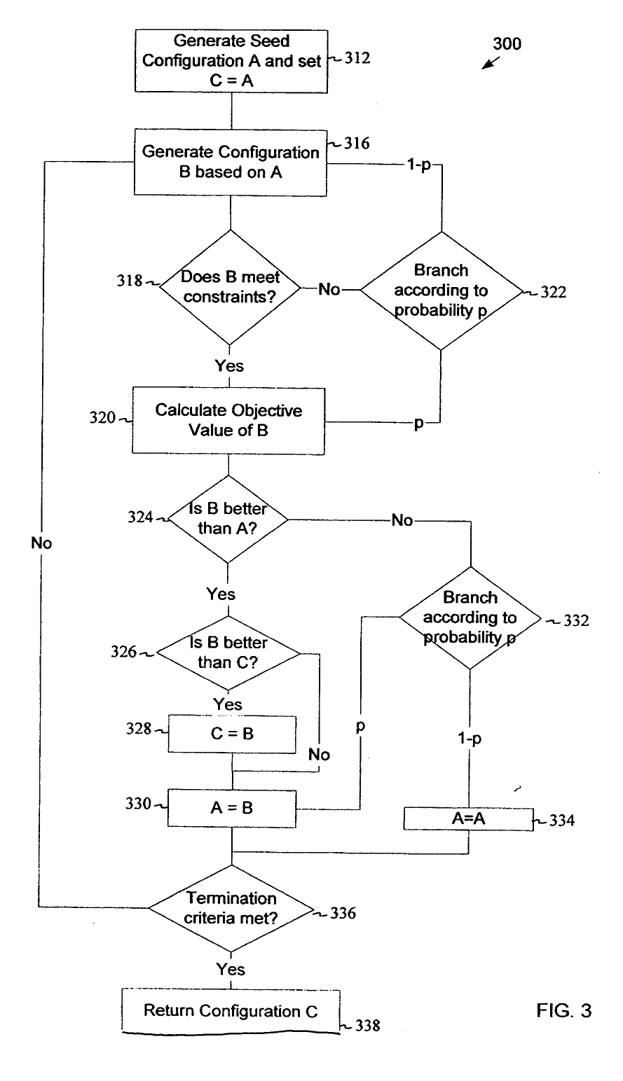

Further details on the operation of system 100 are provided below with reference to FIGS. 2 and 3.

FIGS. 2 and 3 are flowcharts illustrating methods allocating data structures to various memories or data channels in a system. The methods may be performed within an operating environment such as that described above with reference to FIG. 1. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from machine-readable media such as RAM, ROM, CD-ROM, DVD-ROM, flash memory etc.). The methods illustrated in FIGS. 2 and 3 are inclusive of the acts performed by an operating environment executing an exemplary embodiment of the invention.

FIG. 2 is a flowchart illustrating a method 200 allocating data structures to memories and storage channels according to embodiments of the invention. The method begins by determining memory access bandwidth (block 202). In some embodiments, this comprises determining the aggregate read and write activity between tasks and the data structures in the system. As noted above, this may be accomplished through up-front static analysis of the task software, or through empirical measurement at run-time.

Next, the system determines the storage size constraint (block 204). The storage size constraint comprises the maximum size of each storage channel. The size of data structure d(i) is denoted d(i).size. The size of storage channel C(i) is denoted C(i).size. The data channel to which data structure d(i) is assigned is denoted d(i).channel. For the purposes of the constraint satisfaction algorithm below, the storage size constraint is defined as:

$$∀ j , C ( j ) . size > {\sum }_{∀ i , d ( i ) . channel = j} d ( i ) . size \qquad ( 1 )$$

Next, the system determines the bus bandwidth constraint (block 206). The bus bandwidth constraint states that the available bandwidth between the processor and the storage channel should not be exceeded. Some embodiments assume that read and write activity share a channel. Equation 2 below shows this constraint expressed under the assumption that read and write bandwidth share a channel.

$$∀ j , C ( j ) . bw > {\sum }_{∀ d ( i ) . channel = j} d ( i ) . bw \qquad ( 2 )$$

Where d(i).bw is the sum of the totals of read and write bandwidth for data structure i. In those embodiments using an interference matrix, this amounts to summing a column of the interference matrix. In the example table 1, d(DSO).bw=4, d(DS1).bw=12 and so on.

In alternative embodiments where read and write activity does not share a channel, the constraint can be expressed as two separate constraints, one applying to read bandwidth and the other to write bandwidth.

After determining the applicable constraints, the system uses the constraints to determine an allocation of data structures to memories (storage channels) using a constraint satisfaction algorithm (block 208). The constraint satisfaction algorithm uses an objective function to determine the “fitness” of a particular allocation. The constraint satisfaction algorithm in some embodiments generates and compares multiple potential data structure allocations, and selects the allocation generating the global optimal allocation as defined by the fitness function. The various embodiments of the invention may define fitness in different ways.

In some embodiments, fitness may be defined by measuring how well a particular allocation allocates frequently accessed data structures to faster low latency memories in the system. Let d(i).latency denote the latency of the channel to which d(i) is allocated. Some embodiments normalize this by dividing by the sum of the latencies of access across storage channels:

$$d ( i ) . {latency}^{′} = \frac{d ( i ) . latency}{{\sum }_{j} C ( j ) . latency} \qquad ( 3 )$$

Similarly, some embodiments normalize the bandwidth of accesses to each data structure by dividing by the total bandwidth of accesses to all data structures.

$$d ( i ) . {bw}^{′} = \frac{d ( i ) . bw}{{\sum }_{j} d ( j ) . bw} \qquad ( 4 )$$

Then in some embodiments, the measure of the fitness of a candidate allocation uses the objective function:

$${U}_{latency} = {\sum }_{i} d ( i ) . {bw}^{′} d ( i ) . {latency}^{′} \qquad ( 5 )$$

In these embodiments, the lower the value of the objective function, the better the solution.

Thus the constraints and the objective, or fitness, function discussed above may be applied to the constraint satisfaction algorithm described below with reference to FIG. 3. The resulting algorithm will generate close to optimal allocations of data structures to memories (storage channels) which result in systems in which the overall latency of access to data structures is globally minimized. This is desirable because it may result in faster task execution times.

In alternative embodiments, fitness may be defined by measure how much bandwidth is wasted by a particular allocation, and the constraint satisfaction algorithm uses an objective function that selects an allocation that minimizes wasted bandwidth.

In these embodiments, additional terms are added to the objective function defined previously in equation 5, resulting in a refinement of the allocation to suit particular needs. For instance, many off-chip storage units have a natural minimum burst size. If the size of an access is not an integer multiple of the burst size, bandwidth is wasted.

In these embodiments, the typical size of access to a data structure may be determined either through up-front static analysis of the program or through empirical analysis of a simulation or execution of the program as discussed above. In addition, some embodiments add an extra term in the objective function to penalize allocations which waste bandwidth. Let d(i).accesssize(j) be the size of the j'th access to data structure d(i). Let C(i).burstsize be the minimum burst size of storage channel i. The bandwidth wasted due to burst-size mismatch is then defined as:

$$d ( i ) . bw\_wasted = {\sum }_{j} ( d ( i ) . accesssize ( j ) ) \% ( C ( d ( i ) . channel ) . burstsize ) \qquad ( 6 )$$

In the above equation the “%” denotes the modulus operator.

Next, the system then sums across all data structures to create a new objective function term:

$${U}_{bwefficiency} = {\sum }_{i} d ( i ) . bw\_wasted \qquad ( 7 )$$

In further alternative embodiments, the objective function can be augmented to only penalize wasted bandwidth on highly utilized channels by modifying the summation in the equation as follows:

$${\sum }_{i} ( C ( d ( i ) . channel ) . utilization ) ( d ( i ) . bw\_wasted ) .$$

In these embodiments, wasted bandwidth on highly utilized channels is penalized heavily, while wasting bandwidth on channels that are not heavily utilized is not.

In still further embodiments, the objective function supplied to the constraint satisfaction algorithm can then be encoded as:
U=αU_{latency}+βU_{bweffciency} (8)
where Alpha and Beta are parameters used to tune the trade off between minimizing latency and bandwidth efficiency. For example, if the user is primarily concerned with minimizing latency, a large value of alpha and a small value of beta should be used.

In the above-described method, it is assumed that all tasks are of equal importance. In alternative embodiments, data structure allocations to memories for some tasks adjusted due to the fact that the execution time of some tasks may be more critical than others. For instance, some systems are more concerned with optimizing the latency and speed of execution of a task that performs complex packet processing than one that merely reports statistics occasionally. This can be accommodated into the systems and methods described above by adding a weighting to the rows of the interference matrix. Each row may be weighted according to the importance of optimizing the execution speed of the task that row corresponds to. In these embodiments, the higher the weight, the more important the task. The weight is multiplied by the entries in the row before they are summed column-wise before being fed into the objective function calculations.

FIG. 3 is a flowchart illustrating a method 300 for performing a constraint satisfaction allocation search according to embodiments of the invention. The search method 300 begins by establishing a seed configuration (block 312). The seed configuration is utilized to bootstrap the search routine 300. The seed configuration may be a simple, random assignment of data structures to memories or storage channels. However, the seed configuration may also have a basis for its assignments. For example, a seed configuration may be chosen based on past experiences indicating a high probability that the seed configuration may be close to an optimal configuration. The seed configuration may also be chosen as the simplest configuration (e.g., all data structures assigned to a particular memory), as a configuration distributing an equal number of data structures on each memory, or for any other criteria. The seed configuration may be determined by the search routine 300 or by the programmer. The seed configuration is set as the current configuration, A, and the most optimally known configuration, C, is set as the current configuration A. Because the search routine 300 has only just initialized at block 312, the current configuration A is considered the most optimal configuration found at that particular time. The search routine 300 calculates an objective value using one of the objective functions discussed above for the current configuration A, and stores the objective value in a memory.

The search routine 300 generates a new configuration B based on the current configuration A (block 316). In some embodiments, the process at block 316 follows that of a genetic algorithm or other evolutionary algorithm. In other words, the new configuration B is generated as a variation of the current configuration A. A variation of the current configuration A may be a random or stochastic variation generated according to a genetic operator. By generating a new configuration B based on the current configuration A, the search routine 300 selects new configurations as part of a methodical search throughout the entire search space without evaluating every conceivable configuration. In other words, the search routine 300 progressively searches through the search space by sampling various configurations.

To generate a new configuration B for data store allocation, a data structure is chosen at random (or pseudo-randomly) and moved to a new channel, provided that the chosen channel has sufficient storage and bandwidth overhead. Generally, chains of next neighbor relationships exist, which should be preserved because the likelihood of reconstructing a broken next neighbor chain through random permutation is generally low. If the randomly chosen stage is not part of a chain, the search routine 300 chooses another stage that is also not part of a chain and swaps it for the randomly chosen stage. If the randomly chosen stage is part of a chain, the new configuration B is generated by moving the entire chain up or down one stage, provided the chain is not adjacent to other chains. If the randomly chosen stage is part of a chain, and the chain is adjacent to another chain, the chain, including the randomly chosen stage, is moved up or down by the number of stages in the adjacent chain.

Once the new configuration B has been generated, the search routine 300 may determine whether the new configuration B meets the size and bandwidth constraints as determine at blocks 204 and 206 of the method in FIG. 2 (block 318). The search routine 300 determines whether the new configuration B is a valid configuration based on a constraint satisfaction (CSAT) method, as mentioned above.

If the new configuration B meets the minimum configuration constraints, as determined at block 318, the search routine 300 proceeds to calculate the objective value of the new configuration B per one of the objective functions described above (block 320). If the minimum constraints are not met, the search routine 300 passes control to block 322. At block 322, the search routine 300 determines whether to accept or reject the new configuration B according to a probability P₁. For example, the majority of new configurations B that do not meet the minimum configuration constraints or thresholds may be rejected according to a probability (1−P₁). However, according to the probability P₁, the search routine 300 may accept the new configuration B despite the fact that it does not meet the minimum configuration constraints. As will be explained further below, it is sometimes desirable to keep a new configuration B that does not meet the minimum constraints in order to evolve through a number of configurations that do not meet the constraints, yet gradually improve their quality. In other words, according to a probability P₁, a search routine 300 takes into account that, although the new configuration B being evaluated does not meet minimum constraints, the new configuration B may be used to eventually discover a configuration that does meet the minimum constraints. In some cases, no configuration will meet the minimum configuration constraints or thresholds, yet it may still be desirable to return the best possible configuration encountered by the search routine 300.

The probability P₁ may be set to any desired value and may be variable to suit the morphology of the search space. For example, the probability P₁ may be determined by the programmer, or the probability P₁ may be initially set at a default value which varies as the search routine 300 performs numerous iterations. In one example, the probability P₁ varies according to the number of iterations performed by the search routine 300, such that the probability P₁ may decrease in value as fewer and fewer potential configurations remain within the search space. In another example, the probability P₁ varies according to previously encountered configurations, such that, despite failing to meet the minimum configuration constraints, the new configuration B is considered an improvement over the current configuration A, and the probability P₁ may be increased to indicate a higher probability that a valid configuration may eventually be found based on this perceived trend of improving. If the search routine 300 rejects the new configuration B according to the probability (1−P₁), control returns to block 316 to generate another new configuration B based on the current configuration A. If the search routine 300 at block 322 accepts the new configuration B, based on the probability P that it may ultimately yield a valid configuration, control passes to block 320 where the search routine 300 calculates the objective value of the new configuration B.

The search routine 300 then calculates the objective value as defined above for the new configuration B (block 320). As explained above, the objective value may characterize how well the new configuration B allocates data structures to the available memories.

The search routine 300 next determines whether the new configuration B is better than the current configuration A by comparing their respective objective values (block 324). In other words, the search routine 300 determines whether or not the new configuration B has a better degree of data structure allocation optimization or fitness than the current configuration A. As discussed above, a lower objective value generally indicates the configuration is closer to an optimal configuration than a configuration having a higher objective value.

If the new configuration B is determined to be better than the current configuration A, the search routine 300 passes control to block 326 where the search routine 300 determines whether the new configuration B is better than the most optimally known configuration C. The determination made at block 326 may be based on the same criteria as the determination made at block 324. If the new configuration B is better than the most optimally known configuration C, control passes to block 328 where the most optimally known configuration C is updated and redefined with the parameters of the new configuration B. In other words, because the new configuration B is determined to be better than the most optimally known configuration C, the new configuration B now becomes the most optimally known configuration C. Control then passes to block 330 where the current configuration A is updated and redefined with the parameters of the new configuration B. That is, the search routine 300 will now use the new configuration B as the current configuration A to generate further configurations. If, however, the search routine 300 determines at block 326 that the most optimally known configuration C is better than the new configuration B, control passes directly to block 330 where the current configuration A is updated and redefined with the parameters of the new configuration B, and the most optimally known configuration C remains unchanged.

Referring again to block 324, if the search routine 300 determines that the current configuration A is better than the new configuration B, control passes to block 332 where the search routine 300 decides whether or not to keep the new configuration B, despite the fact that the new configuration B is not an improvement over the current configuration A. At block 332, the search routine 300 may reject the new configuration B according to a probability (1−P₂) that a more optimal configuration based on the new configuration B may not exist. The search routine 300 may also accept the new configuration B according to a probability P₂ that the configurations based on the new configuration B may yield more optimal configurations than the current configuration A (i.e., more optimal configurations may exist), despite the fact that the new configuration B is not considered an improvement. In effect, the search routine 300 may be considered a hill-climbing search routine, and the determination at block 332 allows the search routine 300 to avoid being trapped inside a local minima (i.e., region of search space in which only less optimal configurations exist nearby, but in which the local optima is a much less optimal configuration than the global optimum configuration). Instead, the search routine 300 is sometimes forced to take a chance that a more optimal configuration may exist outside a local minima according to the probability P₂.

The probability P₂ at block 332 may be based on the probability P₁ at block 322, described above. For example, the probability P₂ at block 332 may be a variable probability, which varies according to the probability P₁ utilized at block 318. In another example, the probability P₂ utilized at block 332 may be different than the probability P₁ utilized at block 318. For example, the probability P₁ may be based on the probability of encountering a configuration that meets the minimum configuration constraints or thresholds. On the other hand, the probability P₂ may be based on the probability that a configuration better than the current configuration A exists within the remaining search space, and that the new configuration B may be used to generate further configurations that will eventually lead to a more optimal configuration than the current configuration A.

Once the new configuration B has been evaluated to determine whether or not to update the current configuration A and the most optimally known configuration C, the search routine 300 decides whether to continue searching or to terminate the search at block 336. The determination at block 336 may be based on a set of termination criteria, which may be set by the programmer. For example, the search routine 300 may be terminated if the degree of optimization (e.g., the objective value) of the most optimally known configuration C is equal to or better than what is required. The search routine 300 may also be terminated if the most optimally known configuration C has not improved within a predetermined number of iterations of the search routine 300. The search routine 300 may also be terminated at block 336 if the total number of iterations has exceeded a maximum allowable number of iterations. The search routine 300 may thus return an optimal configuration even if the configuration is not the global optimum or best possible configuration. Each of the above criteria may be specified by the programmer, and together may be used to determine the depth of the search for an optimal configuration. For example, the above criteria may be set such that the search routine 300 will terminate and return the first configuration it encounters that meets the configuration constraints or other minimum threshold requirements. In other words, an optimal configuration may be any configuration that meets a minimum set of requirements, and the first such configuration found is returned as the optimal configuration. In other cases, the termination criteria may be set such that the search routine 300 will likely return a global optimal configuration as an optimal configuration.

If the termination criteria is satisfied, as determined at block 336, the search routine 300 returns the most optimally known configuration C as the optimal configuration for allocating resources. Otherwise, control may be returned to block 316, and the search routine 300 generates a new configuration B based on the current configuration A as defined at either block 330 or block 334. In effect, the search routine 300 continues generating new configurations based on previous configurations to progressively search through the search space of all potential configurations for allocating resources. The search routine 300 may include safeguards to avoid being trapped in a local minima, and to further avoid being trapped due to configuration constraints.

Systems and methods for allocating data structures to available memories have been described. The embodiments of the invention provide advantages over previous systems. For example, the systems and methods of various embodiments of the invention may allocated numerous data structures to memories such that latency and/or wasted bandwidth may be reduced over other methods of allocating data structures to memories.

Although specific embodiments have been illustrated and described herein, it will be appreciated by those of ordinary skill in the art that any arrangement which is calculated to achieve the same purpose may be substituted for the specific embodiments shown. The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that the inventive subject matter be limited only by the following claims and equivalents thereof.

What is claimed is:

1. A method comprising:
determining a memory access bandwidth for each of a plurality of data structures, each of the data structures having a data structure size;
determining a storage size constraint for each of a plurality of memories, each of the memories having a memory size;
determining a bus bandwidth constraint for each bus accessing the plurality of memories, each bus having a bus bandwidth; and
determining an allocation of the data structures to the plurality of memories using the storage size constraint and the bus bandwidth constraint in a constraint satisfaction algorithm having an objective function to determine allocation fitness.

2. The method of claim 1, wherein the storage size constraint comprises determining if a sum of the data structure sizes for data structures allocated to a memory exceeds the memory size for the memory.

3. The method of claim 1, wherein the bus bandwidth constraint comprises determining if a sum of the memory access bandwidths for data structures allocated to the memory exceeds the bus bandwidth.

4. The method of claim 1, wherein the objective function includes determining a latency associated with a data structure allocation.

5. The method of claim 1, wherein the objective function includes determining a wasted bandwidth associated with a data structure allocation.

6. The method of claim 1, wherein determining memory access bandwidth includes determining an interference data structure associating the plurality of data structures to a plurality of tasks.

7. The method of claim 1, wherein the plurality of memories includes a scratch-pad memory.

8. The method of claim 1, wherein the plurality of memories includes an external memory.

9. An apparatus comprising:
a processor and a plurality of memories, each of the memories having a memory size;
at least one task executable on the processor; and
a plurality of data structures associated with the at least one task, each of the data structures having a data structure size;
wherein data structures are allocated to a memory of the plurality of memories in accordance with a storage size constraint, a bus bandwidth constraint and an objective function.

10. The apparatus of claim 9, wherein the storage size constraint comprises determining if a sum of the data structure sizes for data structures allocated to a memory exceeds the memory size for the memory.

11. The apparatus of claim 9, wherein the bus bandwidth constraint comprises determining if a sum of the memory access bandwidths for data structures allocated to the memory exceeds the bus bandwidth.

12. The apparatus of claim 9, wherein the objective function includes determining a latency associated with a data structure allocation.

13. The apparatus of claim 9, wherein the objective function includes determining a wasted bandwidth associated with a data structure allocation.

14. The apparatus of claim 9, wherein the plurality of memories includes a DRAM (Dynamic Random Access) memory.

15. The apparatus of claim 9, wherein the plurality of memories includes a scratch-pad memory.

16. The apparatus of claim 9, wherein the plurality of memories includes an off-chip memory.

17. A machine-readable medium having machine readable instructions for executing a method, the method comprising:
determining a memory access bandwidth for each of a plurality of data structures, each of the data structures having a data structure size;
determining a storage size constraint for each of a plurality of memories, each of the memories having a memory size;
determining a bus bandwidth constraint for each bus accessing the plurality of memories, each bus having a bus bandwidth; and
determining an allocation of the data structures to the plurality of memories using the storage size constraint and the bus bandwidth constraint in a constraint satisfaction algorithm having an objective function to determine allocation fitness.

18. The machine-readable medium of claim 17, wherein the storage size constraint comprises determining if a sum of the data structure sizes for data structures allocated to a memory exceeds the memory size for the memory.

19. The machine-readable medium of claim 17, wherein the bus bandwidth constraint comprises determining if a sum of the memory access bandwidths for data structures allocated to the memory exceeds the bus bandwidth.

20. The machine-readable medium of claim 17, wherein the objective function includes determining a latency associated with a data structure allocation.

21. The machine-readable medium of claim 17, wherein the objective function includes determining a wasted bandwidth associated with a data structure allocation.

22. The machine-readable medium of claim 17, wherein determining memory access bandwidth includes determining an interference data structure associating the plurality of data structures to a plurality of tasks.

23. The machine-readable medium of claim 17, wherein the plurality of memories includes a memory selected from the group consisting of a scratch-pad memory, an off-chip memory, and an external memory.

24. The machine-readable medium of claim 17, wherein determining the memory access bandwidth includes weighting the memory access bandwidth according to a task associated with the data structure.

25. A system comprising:
an SRAM (Static Random Access) memory;
at least one task having a plurality of data structures allocatable to a plurality of memories, said plurality including the SRAM memory, each of the memories having a memory size; and
an allocation analysis tool operable to:
determine a memory access bandwidth for each of a plurality of data structures, each of the data structures having a data structure size;
determine a storage size constraint for each of a plurality of memories, each of the memories having a memory size;
determine a bus bandwidth constraint for each bus accessing the plurality of memories, each bus having a bus bandwidth; and
determine an allocation of the data structures to the plurality of memories using the storage size constraint and the bus bandwidth constraint in a constraint satisfaction algorithm having an objective function to determine allocation fitness.

26. The system of claim 25, wherein the storage size constraint comprises determining if a sum of the data structure sizes for data structures allocated to a memory exceeds the memory size for the memory.

27. The system of claim 25, wherein the bus bandwidth constraint comprises determining if a sum of the memory access bandwidths for data structures allocated to the memory exceeds the bus bandwidth.

28. The system of claim 25, wherein the objective function includes determining a latency associated with a data structure allocation.

29. The system of claim 25, wherein the objective function includes determining a wasted bandwidth associated with a data structure allocation.

30. The apparatus of claim 9, wherein the plurality of memories includes a scratch-pad memory.
